(19) United States
(12) Patent Application Publication
(10) Pub. No.: US 2020/0131957 A1
(43) Pub. Date: Apr. 30, 2020

(54) CATALYTIC METAL COATINGS FOR METAL COMPONENTS FOR IMPROVED TRIBOLOGICAL PERFORMANCE IN LUBRICATED SYSTEMS

(71) Applicants: Gary Doll, North Canton, OH (US); Devesh Shreeram, Boise, ID (US)

(72) Inventors: Gary Doll, North Canton, OH (US); Devesh Shreeram, Boise, ID (US)

(21) Appl. No.: 16/629,988

(22) PCT Filed: Jul. 10, 2018
(86) PCT No.: PCT/US2018/041445

§ 371 Date: Jan. 10, 2020

Related U.S. Application Data
(60) Provisional application No. 62/616,109, filed on Jan. 11, 2018.
(60) Provisional application No. 62/530,572, filed on Jul. 10, 2017.

(51) Int. Cl. F01M 9/00; B01J 23/755; C25D 9/04

(52) U.S. Cl. CPC F01M 9/00; C10M 169/04; C25D 9/04; B01J 23/755

(57) ABSTRACT

A lubricated system is taught including at least one metal component in motion. The at least one metal component is lubricated by a lubricant including organic oil additives and the at least one metal component is coated with a catalytic material.

### FIELD OF THE INVENTION

The present invention relates to material coatings, more particularly, to coatings on metal components employed in lubricated systems, the coatings serving to improve tribological performance.

### BACKGROUND OF THE INVENTION

Tribological coatings have been shown to substantially improve the performance of many mechanical components. Developing a single coating with enhanced endurance to contact fatigue, pitting, wear, scuffing and other issues has become a major area of interest for coatings and tribology experts.

Most lubricated mechanical systems operate in the boundary or mixed lubrication regime where direct metal/metal contact occurs that can increase friction and wear. Therefore, friction modifiers are added to the synthetic and mineral oils employed in these lubricated systems to adjust friction characteristics and improve lubricity and energy efficiency. There are two primary types of friction modifiers: metallo-organic compounds and organic polymer compounds. In situations where friction modifiers are not applicable, extreme pressure (EP) and anti-wear (AW) additives are used. The most widely used EP and AW additives are molybdenum dialkyldithiophosphates (MoDTP), molybdenum dithiocarbamates (MoDTC) and zinc dialkyldithiophosphate (ZDDP). In addition to the EP and AW additives, detergents, dispersants, anti-foaming agents, anti-oxidation and anti-corrosion additives are also added in several off-the-shelf fully-formulated (FF) oils. Detergents are usually calcium- or magnesium-based compounds used to neutralize and suspend the acidic oxidation and combustion products in the oils. Whereas, the dispersants are organic compounds that can help keep insoluble products suspended in the solution, the anti-corrosion inhibitors are generally divided into two categories based on the type of substrate being used i.e. ferrous or non-ferrous. However, both types use the same approach of adsorbing on the surface to reduce the efficiency of the corrosion by-products from reaching the metallic surface. However, this adsorption process has been argued to decrease the effectiveness of other additives in the fully-formulated oils.

EP and AW additives are known to decompose and to form tribofilms in Hertzian contacts at elevated temperatures and pressures. The thicker and more durable the tribofilm, the less friction and wear will occur in the tribological contact. It is believed that the catalytic activity of the substrate also plays a role in developing tribofilms in the contacts. Evans et al. compared the tribofilm formation on case carburized AISI 3310 and through-hardened AISI 52100 tested under identical conditions. It was hypothesized that the presence of Ni in the AISI 3310 steel could have contributed to the formation of thicker and more durable tribofilms than the Ni-free AISI 52100 steel. Furthermore, Evans et al. noticed that although the compositions of the tribofilms was similar, their microstructures were distinct.

Tribological performance of electrodeposited NiW coatings has been observed previously. These previous studies were performed in dry conditions and were correlated with grain size, hardness, and W atomic percent. In general, increasing W at % was found to decrease grain size and increase dry sliding wear resistance. Transfer of material and formation of oxides has also been correlated with the increasing dry sliding wear resistance. Some of the studies showed improved tribological performance through incorporation of particles like ZrO₂, TiO₂, Al₂O₃, PTFE, CNT, and nano-diamonds.

Despite current research and developments, there always remains a need for improvement in tribological performance in lubricated systems, and the present invention is directed to such improvements

### SUMMARY OF THE INVENTION

In a first embodiment, the present invention provides a lubricated system comprising at least one metal component in motion and lubricated by a lubricant including organic oil additives, wherein the at least one metal component is coated with a catalytic material.

In a second embodiment, the present invention provides a lubricated system as in any embodiment above, wherein the presence of the catalytic metal improves the tribological performance of the system as compared to an identical system without the catalytic metal coated on the at least one metal component.

In a third embodiment, the present invention provides a lubricated system as in any embodiment above, wherein the at least one metal component is selected from the group consisting of automotive drivetrain systems including engines, transmissions, axle centers, wheel ends, power transmission devices in construction, mining, agriculture, and aerospace applications, shafts, bearings, bushings, gears, rollers, rolling bearings, plain bearings, gears, pistons, piston rings, tappets, and seals.

In a fourth embodiments, the present invention provides a lubricated system as in any embodiment above, wherein the at least one metal component is made of metals or metal alloys selected from steel, aluminum, magnesium alloy, titanium alloy, and metal matrix composites.

In a fifth embodiments, the present invention provides a lubricated system as in any embodiment above, wherein the at least one metal component is made of metals or metal alloys selected from hypoeutectic steel or hypereutectic steel.

In a sixth embodiments, the present invention provides a lubricated system as in any embodiment above, wherein the at least one metal component is made of AISI 52100 steel.

In a seventh embodiments, the present invention provides a lubricated system as in any embodiment above, wherein the lubricant is selected from the group consisting of petroleum-based oils, semi-synthetic oils, synthetic oils, greases with mineral or synthetic oil, di-ester oils, and silicone oils.

In an eighth embodiments, the present invention provides a lubricated system as in any embodiment above, wherein the organic oil additives are selected from the group consisting of extreme pressure additives, anti-wear additives, friction modifiers, detergents and combinations thereof.

In a ninth embodiments, the present invention provides a lubricated system as in any embodiment above, wherein the catalytic material is selected from the group consisting of catalytic metals and catalytic metal alloys.

In a tenth embodiments, the present invention provides a lubricated system as in any embodiment above, wherein the catalytic metals are selected from the group consisting of nickel, palladium, platinum, copper, silver, and gold.

In a eleventh embodiments, the present invention provides a lubricated system as in any embodiment above, wherein the catalytic metal alloys include catalytic metals and a secondary alloying elements; wherein the catalytic metals of the catalytic metal alloys are selected from the group consisting of nickel, palladium, platinum, copper, silver, and gold; and wherein the secondary alloying elements of the catalytic metal alloys are selected from the group consisting of tungsten, phosphorous, vanadium, molybdenum, iron, and copper.

In a twelfth embodiments, the present invention provides a lubricated system as in any embodiment above, wherein the catalytic metal alloy is selected from the group consisting of NiW, NiP, NiCu, PdCo, MoCu, and NiV.

In a thirteenth embodiments, the present invention provides a lubricated system as in any embodiment above, wherein the catalytic material is coated on the at least one metal component by an electrochemical deposition technique, wherein the electrochemical deposition technique is selected from the group consisting of direct current electrochemical deposition, pulsed current electrochemical deposition, and pulse reverse current (PRC) electrochemical deposition.

In a fourteenth embodiments, the present invention provides a lubricated system as in any embodiment above, wherein the catalytic material is coated on the at least one metal component in layers using pulse reverse current (PRC) electrochemical deposition, and wherein the number of layers coated is between about 5 and about 200.

In a fifteenth embodiments, the present invention provides a lubricated system as in any embodiment above, wherein the thickness of the layers is between about 1 micron to about 50 microns.

In a sixteenth embodiments, the present invention provides a lubricated system as in any embodiment above, wherein the catalytic material further comprises a doping material, wherein the doping material is selected from the group consisting of oxides, carbon allotropes, and non-conductive polymers.

In a seventeenth embodiments, the present invention provides a lubricated system as in any embodiment above, wherein the coated catalytic material has a hardness of from 7 GPa or more to 11.5 GPa or less.

In an eighteenth embodiment, the present invention provides a method for improving the tribological performance of a metal component in motion in a lubricated system including a lubricant with organic oil additives, the method comprising the steps of: depositing a catalytic material on the metal component.

In a nineteenth embodiment, the present invention provides a method for improving the tribological performance, wherein the catalytic material is deposited on the metal component utilizing pulsed reverse current electrochemical deposition.

In a twentieth embodiment, the present invention provides a method for improving the tribological performance, wherein during the process of the pulsed reverse current electrochemical deposition, an electrolyte solution is used, the metal component acts as a cathode, and the catalytic material acts as an anode.

In a twenty-first embodiment, the present invention provides a method for improving the tribological performance, wherein during the process of the pulsed reverse current electrochemical deposition, the metal component acts as a cathode, the catalytic material is made available in an electrolyte solution, and materials such as platinum, graphite or stainless steel act as an anode.

In a twenty-second embodiment, the present invention provides a method for improving the tribological performance, wherein the process of the pulsed reverse current electrochemical deposition utilizes a waveform with cathodic and anodic currents.

In a twenty-third embodiment, the present invention provides a method for improving the tribological performance, wherein the cathodic current has a current density of from 5 mA/cm² or more to 80 mA/cm² or less and the anodic current has a current density of from 0 mA/cm² or more to 50 mA/cm² or less.

In a twenty-fourth embodiment, the present invention provides a method for improving the tribological performance, wherein the cathodic current has a pulse time of from 2 ms or more to 1000 ms or less and the anodic current has a pulse time of from 1 ms or more to 800 ms or less.

In a twenty-fifth embodiment, the present invention provides a method for improving the tribological performance, wherein the deposited catalytic materials have a hardness of from 7 GPa or more to 11.5 GPa or less.

### BRIEF DESCRIPTION OF THE DRAWINGS

FIG. 1 is a schematic representation of an electrodeposition apparatus;

FIG. 2 is a schematic representation of one deposition pulse in a pulsed reverse current mode of electrochemical deposition;

FIGS. 3a, 3b, and 3c show friction coefficients versus temperature (40, 80 and 120 C; FIG. 3a), frequency (20, 40 and 60 Hz; FIG. 3b) and distance (144 m, 288 m and 432 m; FIG. 3c);

FIGS. 4a, 4b, and 4c provide graphs of ball wear vs increasing temperature (40, 80 and 120 C; FIG. 4a) with fixed frequency 20 Hz and distance 144 m; vs increasing frequency (20, 40 and 60 Hz; FIG. 4b) with fixed temperature 120 C and distance 144 m; and vs increasing distance (144, 288 and 432 m; FIG. 4c) with fixed temperature 120 C and frequency 20 Hz, for NiW coated and uncoated AISI 52100 samples with uncoated AISI 52100 balls;

FIGS. 5a, 5b, and 5c provide graphs of disk wear vs. increasing temperature (40, 80 and 120 C; FIG. 5a) with fixed frequency 20 Hz and distance 144 m; vs increasing frequency (20, 40 and 60 Hz; FIG. 5b) with fixed temperature 120 C and distance 144 m; and vs increasing distance (144, 288 and 432 m; FIG. 5c) with fixed temperature 120 C and frequency 20 Hz, for NiW coated and uncoated AISI 52100 samples with uncoated AISI 52100 balls; and

FIG. 6 shows multiple SEM images of wear scars of NiW coated sample with mineral oil (A); uncoated 52100 steel with mineral oil (B); NiW coated sample with fully formulated (FF) oil (C); and uncoated 52100 steel with FF oil (D).

### DETAILED DESCRIPTION OF ILLUSTRATIVE EMBODIMENTS

The present invention provides lubricated systems including at least one metal component in motion and lubricated by a lubricant including organic oil additives. As used herein, organic oil additives include one or more of extreme pressure additives (EP additives), anti-wear additives (AW additives), friction modifiers, and detergents. The metal components are coated with catalytic metals and/or catalytic metal alloys to improve tribologic performance of the lubricated system, the catalytic metals causing an increase in tribofilm thickness. Incorporation of a catalytic metal-based coating is shown here to produce thicker and more durable additive-derived tribofilms that can reduce friction and wear of machine elements in boundary lubricated environments.

The metal components can be virtually any metal component employed in lubricated systems employing organic oil additives. These include, without limitation, automotive drivetrain systems including engines, transmissions, axle centers, wheel ends, power transmission devices in construction, mining, agriculture, and aerospace applications, shafts, bearings, bushings, gears, rollers, rolling bearings, plain bearings, gears, pistons, piston rings, tappets, and seals. Similarly, the metal components may be made of virtually any metal or metal alloy employed in lubricated systems employing organic oil additives.

In some embodiments, the metal components are made of metals or metal alloys selected from steel, aluminum, magnesium alloy, titanium alloy, and metal matrix composites.

In some embodiments, steel may be selected from hypoeutectic steel or hypereutectic steel.

In particular embodiments, the metal component is made from AISI 52100 steel.

The lubricants can be virtually any lubricant employed in lubricated systems employing organic oil additives. These include, without limitation, petroleum-based oils, semi-synthetic oils, synthetic oils, greases with mineral or synthetic oil, di-ester oils, and silicone oils. In some embodiments, the petroleum-based oils are selected from paraffinic, napththenic, or aromatic mineral oils. In some embodiments, hydrocarbon synthetic oils are selected from cycloaliphatics, polyglycols, silicon analogues of hydrocarbons such as silicones and silahydrocarbons, and organohalogens such as perfluoropolyethers, chlorofluorocarbons, chlorotrifluoethylenes, or perfluoropolyalkylethers.

The lubricants include organic oil additives designed to improve the wear and friction characteristics, improve the oxidation resistance, control corrosion, control contamination by reaction products, modify the viscosity, or otherwise enhance the lubricant characteristics. In some embodiments, the wear and friction improvers are organic oil additives that produce tribofilms during the operation of the lubricated system.

Wear and friction improvers include friction modifiers (fatty acids and the esters and amines of the same fatty acids that react with contacting surfaces through the mechanism of adsorption), anti-wear (AW) additives (phosphate containing materials that protect contacting surfaces at temperatures above the range of effectiveness of the friction modifiers), and extreme pressure additives (sulfur or chlorine containing molecules that react with metal surfaces under extreme conditions of load and speed).

In some embodiments, the organic oil additives are selected from EP additives, AW additives, friction modifiers, anti-oxidants, corrosion control agents, contamination control agents, viscosity improvers, pour point depressants, foam inhibitors, detergents (also known as dispersants), and mixtures of the forgoing. EP additives, AW additives, and friction modifier additives are often proprietary but are marketed and used as extreme pressure additives or anti-wear additives or friction modifiers as appropriate for a given system, and these terms should be broadly interpreted with this understanding as well as general descriptions to follow. As the name implies, EP additives are often employed in lubricated systems under extreme pressure (such as gearboxes) while AW additives are often employed in systems with lighter loads (such as bushings and hydraulic and automotive engines). It is appreciated by those of ordinary skill in the art that many AW additives function as EP additives, for example organophosphates, sulfur compounds and chlorinated paraffins.

In some embodiments, EP additives contain organic sulfur, phosphorus or chlorine compounds, including sulfur-phosphorus and sulfur-phosphorus-boron compounds, and chemically react with the metal surface under high pressure conditions. Under such conditions, small irregularities on the sliding surfaces cause localized flashes of high temperature (300-1000 ° C.), without significant increase of the average surface temperature. The chemical reaction between the additives and the surface is confined to this area.

In some embodiments, the EP additives are selected from organic sulfur, phosphorus or chlorine compounds. In some embodiments, the EP additives are selected from dibenzyldisulphide, tricholorcetane and chlorinated paraffin, paraffinic mineral oils and waxes, sulphurchlorinated sperm oil, sulphurized derivatives of fatty acids and sulphurized sperm oil, molybdenum disulphide, and nanoparticles (e.g., nickel oxythiomolybdate, pentaerythritoltetraester, lanthanum fluoride, copper, and others). In some embodiments, the EP additives are selected from esters of chlorendic acid. In some embodiments, the EP additives are selected from polymer esters. In some embodiments, the EP additives are selected from polysulfides. In some embodiments, the EP additives are selected from molybdenum compounds. In some embodiments, the EP additives are selected from organophosphates, in some embodiments, organophosphates with zinc.

In some embodiments, the EP additives are selected from sulfur-phosphorous and sulfur-phosphorus-boron compounds. In some embodiments, the EP additives are selected from molybdenum dialkyldithiophosphates (MoDTP), molybdenum dithiocarbamates (MoDTC), and zinc dialkyldithiophosphate (ZDDP).

In some embodiments, AW additives are additives employed to prevent metal-to-metal contact between moving parts of a lubricated system. In some embodiments, the AW additives are selected from organophosphates, in some embodiments, organophosphates with zinc. In some embodiments, the AW additives are selected from zinc dithiophosphate (ZDP) and zinc dialkydithiophosphate (ZDDP). In some embodiments, the AW additives are selected from tricresyl phosphate (TCP). In some embodiments, the AW additives are selected from halocarbons, in some embodiments, chlorinated paraffins. In some embodiments, the AW additives are selected from glycerol mono oleate.

Contamination control is provided by detergents, also known as dispersants. The primary functions of these additives are to neutralize acids formed during the burning of fuel, prevent lacquer and varnish formation, and prevent flocculation or agglomeration of particles and carbon deposits. There are two types of dispersants: mild and over-based. Mild dispersants are composed of simple hydrocarbons or ashless compounds, typically low molecular weight polymers of methacrylate esters, long chain alcohols, or polar vinyl compounds. The function of these additives is to disperse soot (carbon) and wear particles. Over-based dispersants are calcium, barium, or zinc salts of sulphonic, phenol, or salicylic acids.

The detergents employed that can contribute to tribofilm production are selected from mild detergents and over-based detergents. In some embodiments, the detergents are mild detergents of polymers of methylacrylate esters, long chain alcohols, or polar vinyl compounds. In some embodiments, the catalytic material (see below) is selected from Ni and W, and the detergent is a mild detergent. In some embodiments, the detergents are selected from calcium, barium, and zinc salts of sulphonic, phenol, or salicylic acids. An over-based detergent is defined herein as a detergent that has an excess of alkali employed in its preparation.

The lubricant may include other known organic oil additives in common amounts. Such additives include, without limitation, detergents, dispersants, anti-foaming agents, anti-oxidation, and anti-corrosion additives.

The metal components are coated with a catalytic material. The term catalytic material is defined herein to include both catalytic metals and catalytic metal alloys to enhance the creation of tribofilms. By “catalytic metals” it is meant any metal that can share electrons to proactively form a bond with the organic oil additives in the lubricant of the lubricated system. By “catalytic metal alloys” it is meant any alloy that includes a catalyst metal and a secondary alloying element. In some embodiments, the catalytic metals are selected from transition metals. In some embodiments, the catalytic metals are selected from d-block transition metals, and in some embodiments, group 4 metals. In some embodiments, the catalytic metal is a metal having between 1 or more and 10 or less d electrons. In some embodiments, the catalytic metal is selected from nickel, palladium, platinum, copper, silver, and gold. In some embodiments a secondary alloying element is selected from tungsten, phosphorous, vanadium, molybdenum, iron, and copper. In some embodiments, the catalytic metal alloy is selected from NiW, NiP, NiCu, PdCo, MoCu, and NiV.

The catalytic material may be deposited on the metal components by virtually any suitable technique, including, without limitation, chemical vapor deposition, chemical solution deposition, evaporation deposition, thermo-reactive deposition, and electrochemical deposition. In some embodiments, the catalytic material is deposited by electrochemical deposition techniques selected from direct current electrochemical deposition, pulsed current electrochemical deposition, and pulse reverse current (PRC) electrochemical deposition. In some embodiments, the catalytic material is deposited by PRC electrochemical deposition.

When using PRC, the catalyst metals are deposited in layers where each pulse from a layer. In some embodiments, the number of layers ranges from 1 or more to 10 s of thousands or less. In some embodiments, the number of layers ranges from 1 or more to 10,000 or less. In other embodiments, the number of layers ranges from 1 or more to 300 or less, in other embodiments, from 1 or more to 200 or less, and, in other embodiments, from 1 or more to 100 or less.

In some embodiments, the number of layers is 1 or greater. In other embodiments the number of layers is 5 or greater, in other embodiments, 100 or greater, and, in other embodiments 300 or greater.

In some embodiments, the number of layers is 300 or less. In other embodiments the number of layers is 200 or less, in other embodiments, 100 or less, and, in other embodiments 10 or less.

In some embodiments, each layer can have a thickness of from 10 nm or more to 20 microns or less. In some embodiments, the thickness of each layer is from 5 nm or more to 1 micron or less.

In some embodiments the total thickness of all the one or more layers is from 1 micron or more to 50 microns or less. In some embodiments, the total thickness of all the one or more layers is from 1 micron or more to 30 microns or less, in some embodiments, from 1 micron or more to 10 microns or less.

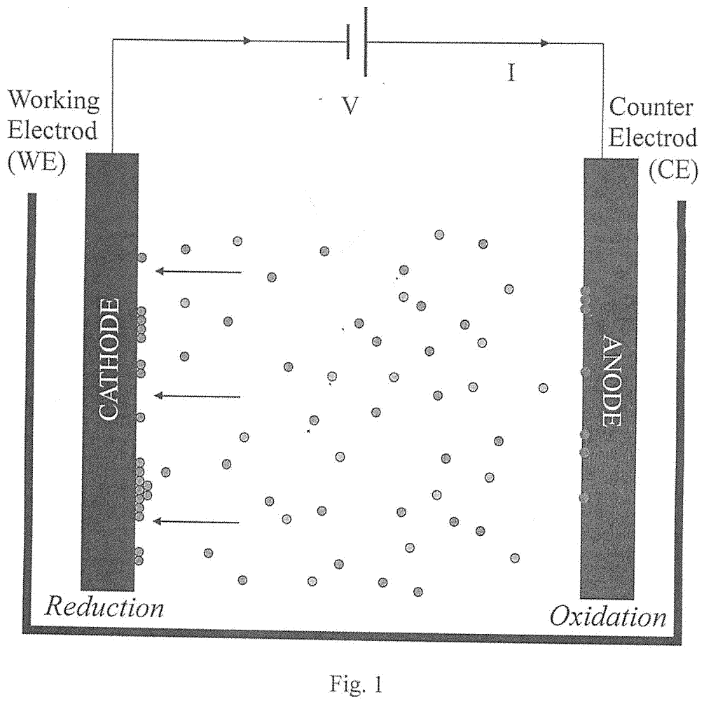

In some embodiments, the catalytic metal or catalytic metal alloy is deposited by electrochemical deposition. Know methods of electrodeposition can be employed. In some embodiments, as shown schematically in FIG. 1, the electrochemical deposition is carried out in a two-electrode configuration, when the metal component to be coated serves as the cathode, and the metal or catalyst metal and secondary alloying elements are made available either as ions in an appropriately chosen electrolyte or as the anode in a solid state. Current is passed through the electrodes to cause an oxidation reaction at the anode and reduction reaction at the cathode.

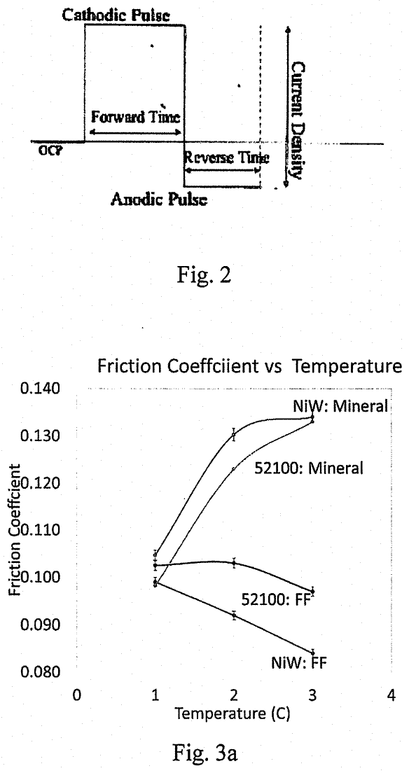

In some embodiments, the electrochemical deposition is pulsed reverse current (PRC) electrochemical deposition. The pulsed reverse current (PRC) mode employs a waveform with cathodic (forward) and anodic (reverse) current pulsed for defined periods. This is schematically represented in FIG. 2. This procedure is effective in redistributing ions in the double layer and the bulk solution. Moreover, PRC process can help resolve several problems like hydrogen evolution, formation of metallic hydrides, oxides, uneven deposits, composition variations, overpotential issues, decreased current efficiency, and even local pH variations. The PRC technique can theoretically deposit coatings more efficiently than the direct current (DC) and pulsed current (PC) modes. PRC based coatings have been reported to have fewer pores, cracks and lower internal stresses than coatings deposited through DC and PC electrochemical deposition. Moreover, the structural, mechanical and corrosion properties can also be tailored by varying parameters like pH, temperature, current densities and deposition/reverse time.

In some embodiments, a forward or cathodic current is applied at the cathode for a period of forward pulse time at a particular forward current density, and then a reverse or anodic current is applied for a period of reverse pulse time at the anode at a particular reverse current density. Theoretically, every pulse produces one layer of catalyst metal/alloy deposition.

Forward current density controls the deposition rate and amount of metals/secondary alloy element complexes reducing on the surface of the cathode. In some embodiments, the forward current density is from 5 mA/cm² or more to 80 mA/cm² or less. In other embodiments, the forward current density is from 10 mA/cm² or more to 50 or mA/cm² or less, in some embodiments, from 20 mA/cm² or more to 40 mA/cm² or less. The forward pulse time can range from milliseconds to seconds. In some embodiments, the forward pulse time is from 2 ms or more to 1000 ms or less. In some embodiments, the forward pulse time is from 10 ms or more to 200 ms or less, in other embodiments, from 20 ms or more to 100 ms or less.

Reverse current density determines the rate of removal and re-distribution of ions from the diffusion layer on the anode to the solution. In some embodiments, the reverse current density is from greater than 0% to 80% or less of the forward current density. In other embodiments, the reverse current density is from 30% or more to 70% or less of the forward current density, and, in other embodiments, from 40% or more to 60% or less.

In some embodiments the reverse current density is from greater than 0 mA/cm² to 50 mA/cm² or less. In other embodiments, the reverse current density is from 4 mA/cm² or more to 30 or mA/cm² or less, and, in some embodiments, from 10 mA/cm² or more to 20 mA/cm² or less. In some embodiments, the reverse pulse time is from greater than 0% to 50% or less, and, in other embodiments, from 10% or more to 30% or less.

The reverse pulse time can range from milliseconds to seconds. In some embodiments, the reverse pulse time is from 1 ms or more to 800 ms or less. In some embodiments, the reverse pulse time is from 2 ms or more to 200 ms or less, and, in other embodiments, from 10 ms or more to 100 ms or less.

In some embodiments, the electrolyte temperature is from 25° C. or more to 80° C. or less. In other embodiments, the temperature is from 35° C. or more to 70° C. or less, and, in other embodiments from 45° C. or more to 60° C. or less.

In some embodiments, the pH of the electrolyte is established at 5.5 pH or more to 10 pH or less. In other embodiments, the pH is from 6 pH or more to 9.5 pH or less, in other embodiments, from 7 pH or more to 9 pH or less, and, other embodiments, from 7.5 pH or more to 8.5 pH or less.

In some embodiments, the coatings have a hardness of from 7 GPa or more to 11.5 GPa or less. In other embodiments, the coatings have a hardness of from 8 GPa to 11 GPa or less, and, in other embodiments, from 9 GPa or more to 9.5 GPa or less.

In some embodiments, the coatings have a grain size of from 7 nm or more to 70 nm or less. In other embodiments, the coatings have a grain size of from 10 nm or more to 50 nm or less, and, in other embodiments, from 20 nm or more to 25 nm or less.

In some embodiments, the catalyst metal/alloy coatings are doped with Oxides (TiO2, Al2O3, ZrO2, ZnO, etc) Carbon Allotropes (Graphene, single/multi Carbon nanotubes, fullerenes) and non-conductive polymers. In some embodiments, the dopants are selected from PTFE, TiO₂, and graphene. If present, the dopants are added in the electrolyte and if present, they are included in an amount of from 1 mg/L to about 10 mg/L.

### EXAMPLES

This experiment focused on the tribological performance of pulse reverse current (PRC) based electrodeposited NiW coatings in lubricated conditions. NiW and AISI 52100 steel disks were tested against AISI 52100 steel balls using mineral oil and a fully-formulated (FF) oil as lubricants. Results revealed that the tests of NiW coatings in the FF oil had no measurable wear and had the lowest friction coefficients (0.084±0.001). The wear scar analysis revealed that the tribofilms formed on the NiW had distinct calcium and oxygen based “pad-like” structures. The results show that the developed PRC based NiW coatings may be an attractive candidate for mechanical components in powertrain applications

The effects of varying contact temperature, sliding frequency and distance were measured by a high frequency reciprocating contact pin on disk tribometer (HFRR). NiW coated and uncoated AISI 52100 steel disks were tested against AISI 52100 steel balls in a mineral oil and a fully-formulated oil. The composition and structure of tribofilms generated on the surfaces of the coated and uncoated disks were examined by scanning electron microscopy (SEM), energy dispersive x-ray spectroscopy (EDXS) and x-ray photoelectron spectroscopy (XPS).

### Materials Synthesis and Characterization:

### Coatings Development:

Substrates of 10 mm diameter×2 mm thick AISI 52100 steel disks through-hardened to 60 HRc and a surface finish of Ra ˜5 nm were used in this study. The coatings were deposited on a fixed 0.45 cm2 surface area. Prior to the deposition, the substrates were first rinsed in deionized (DI) water, then IPA, and finally again in DI water to remove organic contaminants from the surface. The substrates were activated by etching in concentrated HC for 10 s. The electrolyte used for the electrodeposition of all the NiW coatings was composed of 0.06 M NiSO4.6H2O (J. T. Baker), 0.14 M Na2WO4.2H2O (Fisher Chemicals), 0.5 M NH4Cl (EMD Chemicals, NJ, USA), 0.15 M NaBr (Fisher Chemicals), and a complexing agent of 0.5 M C6H8O7.H2O (Fisher Chemicals). The pH of the solution was adjusted to 6.0 using NH4OH/HCl and the bath temperature was held at 65° C. for all the experiments.

Electrodeposition was performed in a two-electrode configuration using a potentiostat (VersaSTAT3, AMETEK, Inc., PA, USA). The samples and a platinum mesh were used as the cathode and anode, respectively. A two-step technique was used to deposit the coatings. In step 1, a cathodic current density of 40 mA/cm2 was applied for 40 s, and in step 2, an anodic pulse current density of 5 mA/cm2 was applied for duration τ=1 s. The charge of the forward pulse (40 mA/cm2×40 s=1.6 C/cm2) and the charge for the total deposition (1.6 C/cm2×80 Pulses=128 C/cm2) were maintained in all coatings. Theoretically, every pulse (40 mA/cm2 for 40 s) produces one layer of NiW, and 80 pulses should produce 80 layers.

### Characterization:

Compositional mapping and topographical analysis of the tribofilms created during testing were performed using a TESCAN LYRA3 scanning electron microscope (SEM) equipped with energy dispersive spectroscopy (EDS). Additional wear scar composition analysis and depth analysis was performed using PHI VersaProbe II Scanning X-ray Photoelectron Spectrometer Microprobe. XPS depth analysis was performed after argon ion sputtering through 1 keV or 2 keV for 1 or 3 minutes. Voltage values of 1 keV or 2 keV have been estimated to remove ˜3.6 nm/min or ˜5.5 nm/min of SiO2, respectively. The usual thickness of tribofilms on AISI 52100 steel and NiP coatings tested with FF oils has been claimed to be about 100-150 nm. The composition of the FF oil was tested using a Thermo Jarrel-Ash Inductively Coupled Plasma Trace Analyzer (ICP 61E). A Zygo NewView 7300 optical profilometer was used to perform the surface roughness measurements on the coatings at a 20× magnification. The hardness of the coatings and the substrate was measured using a Hysitron TI Premier nano-indenter, which runs on a continuous stiffness mode (CSM). A Berkovich tip was used and a 10 mN load was applied with a 10-second hold time. The instrument calculates the hardness and modulus values using the slope of the unloading curves during the continuous measurement.

### Tribological Testing:

Tribological testing was performed using a PCS High Frequency Reciprocating Rig (HFRR). Prior to starting the experiment, the balls and the disks were rinsed with IPA. Tests were performed with a fixed stroke amplitude of 0.5 mm (2mm stroke length), a fixed load of 10N (Contact Pressure of about 1.41 GPa) and a static fill of 1 ml oil. Uncoated AISI 52100 steel balls with 6 mm diameter were used as the counter-face for all experiments. Temperature (40 C, 80 C and 120 C), frequency (20 Hz, 40 Hz and 60 Hz) and distance (144 m, 288 m and 432 m) were varied using both oils i.e. an un-additized mineral oil with a viscosity of 50 cP at 40 C and a Fully Formulated (FF), commercially available fully-formulated oil with a similar viscosity of 50 cP at 40 C. The viscosity of the additized oil at 100 C was measured to be 7.6 cP. The concentration of the elements in the FF oil measured through ICP-Trace Analyzer are listed in Table 1.

TABLE 1
Elemental metal composition of the FF oil
measured using an ICP-Trace Analyzer

| | Concentration |
|---|---|
| Content | (ppm) |
| Calcium | 3600 ± 360 |
| Phosphorus | 1150 ± 115 |
| Zinc | 1280 ± 128 |
| Magnesium | 100 ± 10 |
| Sulphur | 2500 ± 250 |

25

Two materials pairs were tested, i.e. NiW coated disks with an uncoated AISI 52100 ball and an uncoated AISI 52100 disk with an uncoated AISI 52100 ball. Friction coefficient values were collected by the PCS HFRR tribometer. A Zygo NewView 7300 optical profilometer was used to perform the surface roughness measurements and calculate the disk wear volumes. Ball wear volume was also calculated by observing the radius (r) of the ball scar using an optical microscope. The radius was then used to calculate the height of worn out scar (h) using Eq. 1. The height (h) and scar radius (r) were then used to calculate the wear volume of the ball (Eq. 2).

h(height)=R−(\sqrt{R²}−r²) Equation 1

Ball Wear Volume=⅙πh(h²+3r²) Equation 2

where, R is the radius of the ball (3 mm). Since the wear scars on the disks were small, 3D optical profilometry was used to calculate the volume of the scar. Furthermore, ball and disk wear were modelled as a function of dissipated energy (E_{d}) (Eq. 3).

_E_{d}=Friction Coefficient*Load*Sliding Distance Equation 3

Both disk and ball wear volumes are generally a linear function of dissipated energy so the energy wear coefficient or the alpha parameter (α) is calculated as the slope of the linear least fit to the data according to the equation,

v=αE_{d}+V₀ Equation 4

Where, Vo is correlated to the plastic deformation, formation of wear particle or tribofilm and materials transfer between two surfaces at the start of the test. This article will particularly focus only on the wear rate ((α).

### Results and Discussion:

### Coating Properties

The hardness, roughness, thickness and the tungsten (at %) values of the materials are presented in Table 2. Micrographs of the coatings were observed through the 3D profilometer, and the roughness of the NiW coating was measured to be about 7-9 times greater than the uncoated 52100 disks. The hardness of the NiW coating and the uncoated 52100 were observed to be similar.

TABLE 2
Hardness, Roughness and Thickness of the
uncoated 52100 and the NiW coating

| | Hardness | Roughness | Thickness | |
|---|---|---|---|---|
| Sample | (GPa) | (nm) | (μm) | Tungsten (at %) |
| Uncoated | 7.3 ± 0.5 | 5 ± 1 | NA | NA |
| 52100 | | | | |
| NiW | 6.5 ± 0.5 | 46 ± 10 | 11.3 ± 0.45 | 25 ± 1 |

### Friction

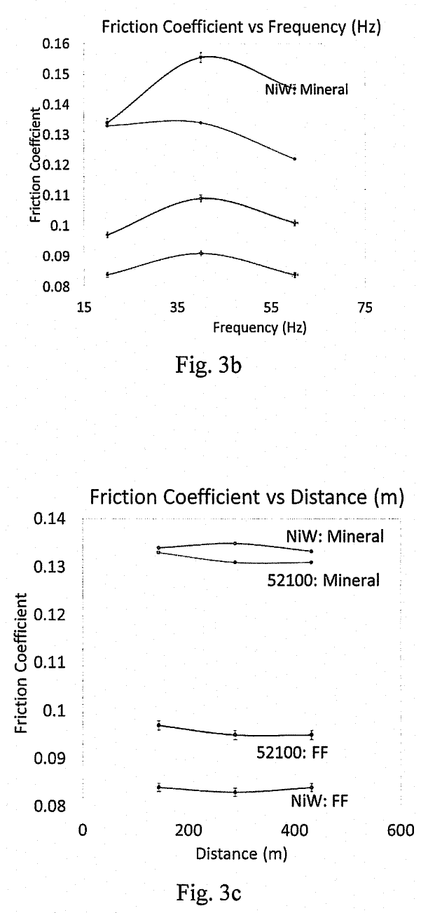

FIGS. 3a, 3b, and 3c show friction coefficients versus temperature (40, 80 and 120 C; FIG. 3a), frequency (20, 40 and 60 Hz; FIG. 3b) and distance (144 m, 288 m and 432 m; FIG. 3c). Comparing all the studies, the friction coefficients of the pairs tested in the

FF oil were lower than the pairs tested in mineral oil. The NiW coating tested in the FF oil had the lowest friction values, while the NiW coating tested in mineral oil had the largest friction. This behavior undoubtedly indicates the influence of additives on the tribological performance of the NiW coatings. Overall the friction coefficient values (high-low) were ranked as follows, NiW Mineral oil>52100 Mineral Oil>52100 FF oil>NiW FF oil.

Changes in temperature with constant frequency (20 Hz) and constant distance (144 m) show that the friction increased for pairs tested in mineral oil and decreased for pairs tested in the FF oil. The decrease in friction with increasing temperature suggests an increased activation of the additives in the FF oil. The increase in friction with increasing temperature is likely due to a thinning or decreased viscosity of the mineral oil, producing thinner lubrication films and increased asperity interactions. The friction coefficient did not vary significantly with change in frequency while keeping temperature (120 C) and distance (144 m) constant. The friction coefficients of all the samples did not vary significantly with distance with temperature (120 C) and frequency (20 Hz) constant.

### Wear

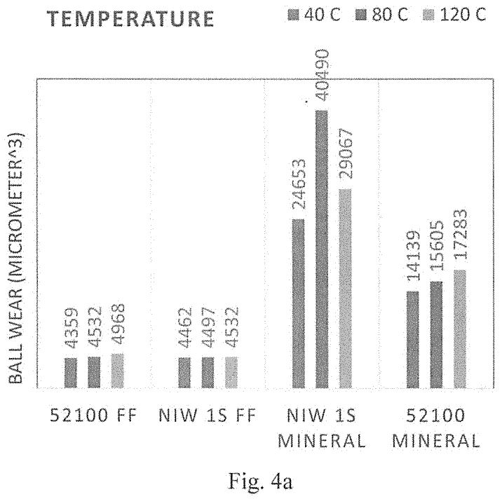

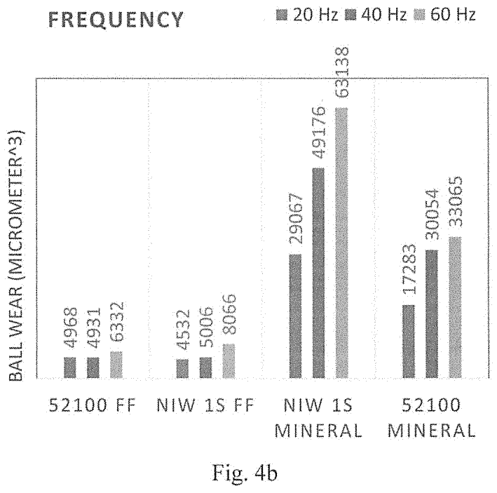

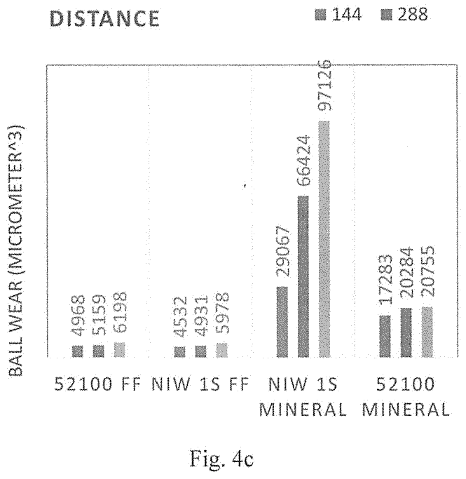

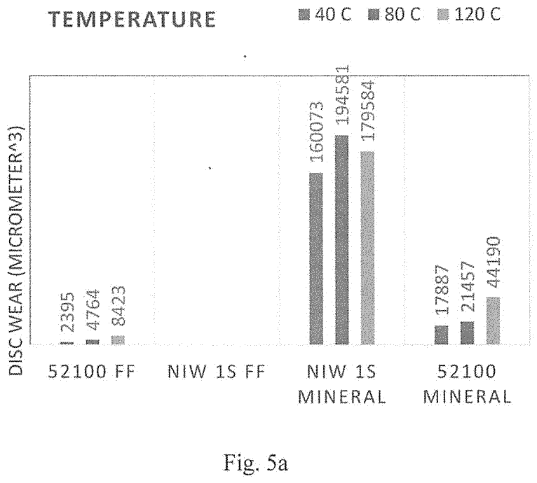

FIGS. 4a, 4b, and 4c show measurements of the ball wear of all tests. Each figure has three plots showing the change in wear with change in temperature (40, 80 and 120 C; FIGS. 4a), frequency (20, 40 and 60 Hz; FIG. 4b) and distance (144 m, 288 m and 432 m; FIG. 4c). Each plot compares the uncoated 52100 and the NiW coated samples tested in mineral and the FF oils.

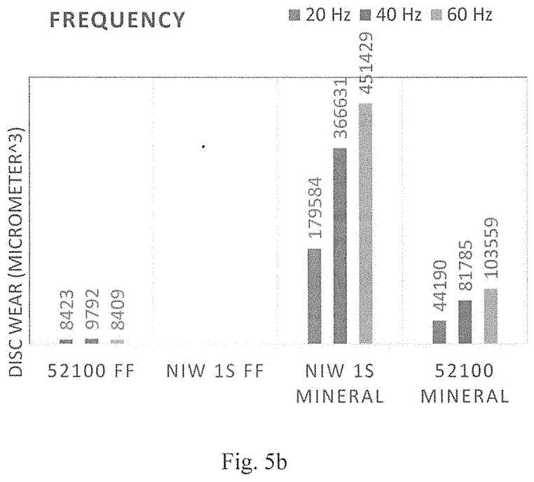

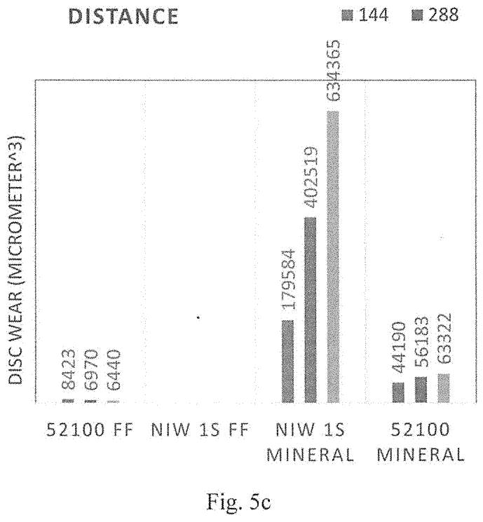

FIGS. 5a, 5b, and 5c show measurements of disc wear of all tests. Each figure has three plots showing the change in wear with change in temperature (40, 80 and 120 C; FIGS. 5a), frequency (20, 40 and 60 Hz; FIG. 5b) and distance (144 m, 288 m and 432 m; FIG. 5c). Each plot compares the uncoated 52100 and the NiW coated samples tested in mineral and the FF oils.

Comparing all the studies in FIGS. 4a-c, the ball wear of the materials pairs tested in mineral oil was found to be greater than those tested in the FF oil. The NiW/mineral oil test exhibited the highest amount of ball wear. Overall the ball wear of all the samples was ranked (high-low) as follows, NiW Mineral oil>52100 Mineral oil>NiW FF Oil=52100 FF oil.

The ball wear did not vary significantly with changes in temperature while keeping frequency (20 Hz) and distance (144 m) constant. A slight increase in ball wear was observed with increasing frequency while keeping temperature (120 C) and distance (144 m) constant. A rapid increase in the ball wear was evident for the NiW/Mineral oil pairing with change in distance while keeping temperature (120 C) and frequency (20 Hz) constant.

Comparing all the studies in FIG. 5a-c, the disk wear of NiW/Mineral oil pairing was found to be higher than all other pairs. The 52100/Mineral oil pair had the second highest disk wear. From the plots, it was also evident that the uncoated specimens with the FF oil had much lower disk wear. However, the most interesting and relevant observation was that the NiW coated sample tested in the FF oil had no measurable wear. Overall the disk wear of all the samples was ranked (high-low) as follows, NiW Mineral oil>52100 Mineral Oil>52100 FF oil>NiW FF oil.

Increases in temperature at constant frequency (20 Hz) and distance (144 m) showed a slight increase in disk wear trends. Increases in frequency at constant temperature (120 C) and distance (144 m) also showed a linear increase in disk wear of pairs tested in mineral oil. Increases in distance with constant temperature (120 C) and frequency (20 Hz) showed a linear increase in the disk wear of both NiW and 52100 pairs tested in mineral oil. Interestingly, a decrease in disk wear with increasing distance of the uncoated pairs tested in the FF oil was observed. Dissipated Energy

The change in wear volume of balls and disks versus the dissipated energy (Ed) was assessed, and the a values and the goodness of fit (R²) values derived from the least square fits of the plots are presented in Table 3. The ball wear a value was lowest (4.5 μm3/J) for the uncoated pair and largest (177 μm3/J) for the NiW/52100 pair when both were tested in mineral oil. Whereas the disk wear a value of the NiW/52100 pair tested in the FF oil was zero since no measurable wear on the disk was observed, the a value of the uncoated pair tested in the FF oil was negative (−4.48 μm3/J). The negative alpha value indicates a decrease in wear volume with distance. The largest value of a obtained from disk wear (1183 μm3/J) was associated with the NiW/52100 pairing tested in mineral oil.

Differences in the disk wear of the NiW coatings tested in mineral and the FF oils suggests that additives in the FF oil play a large role. To further understand the interactions that the additives have on the coated and uncoated disk surfaces, SEM images were collected and XPS depth analysis was performed on the disk wear scars of all 4 combinations (120 C, 20 Hz and 452 m). Furthermore, EDS maps were collected from wear scars (432 m) generated on the NiW coated and uncoated disks tested with in the FF oil.

TABLE 3
The α values calculated through linear square fits of the plots in

| | | Ball | Ball Fit | Disk | Disc Fit |
|---|---|---|---|---|---|
| Lubricant | Sample | (μm³/J) | R² | (μm³/J) | R² |
| Mineral Oil | Uncoated | 9.25 | 0.846 | 77.3 | 0.957 |
| | NiW | 177 | 0.998 | 1183 | 0.999 |
| FF Oil | Uncoated | 4.5 | 0.867 | −4.48 | 0.792 |
| | NiW | 6.0 | 0.943 | 0 | NA |

### Wear Scar Characterization:

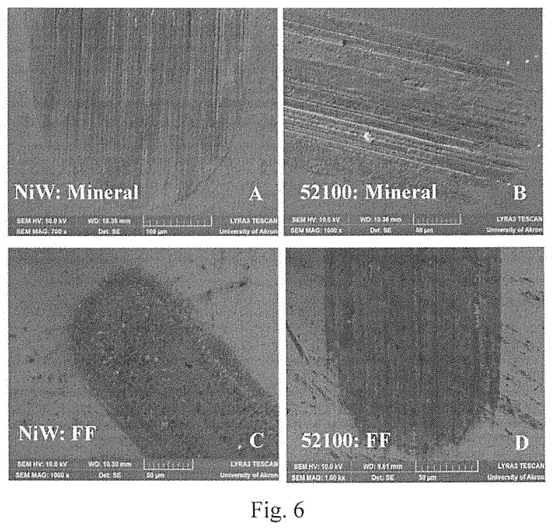

FIG. 6 shows the SEM images of wear scars. The SEM images of pairs tested in mineral oil exhibit abrasive wear marks due to thinning and asperity interactions (metal-metal). The wear scars of the samples tested in the FF oil are distinctly different from the wear scars created in the mineral oil. Since the base oil is the same in both lubricants, it was concluded that the additives in the FF oil assisted in formation of stable tribofilms on the surface of both the coated and uncoated disks. However, it was also noticeable that there is a difference in the structure or appearance of the tribofilms on the coated and uncoated samples tested in the FF oil. Although no measurable wear volume was obtained from the NiW coating tested in the FF oil, the SEM image in FIG. 6 part C clearly shows a distinct region of tribological interaction. Unlike FIG. 6 part C, the SEM image of the uncoated disk tested in the FF oil (FIG. 6 part D) shows a region with light abrasive marks. To further understand the features observed in FIG. 6, XPS depth analysis and EDS mapping was performed on the wear scars. The XPS and EDS data showed the tribofilm was thicker on NiW/FF oil sample.

The elemental composition of the material in the wear scars with depth/time was collected using XPS. Multiple XPS plots were collected from the center of each scar and analyzed while sputtering. Analyzed were: the composition at 0 min i.e. surface, the composition after 1 keV/1 min sputtering, and the compositions at 1 keV/3min, and (only for the NiW tested in the FF oil) the composition after etching with 2 keV for 3 minutes.

Whereas the wear scars of the samples tested in mineral oil were largely composed of C, O, and S, the wear scars of samples tested in the FF oil were composed of C, O, Ca, Zn, S and P. Assuming that the penetration depth of x-rays employed in the XPS experiment is about 1 μm and a typical tribofilm thickness is about 100-150 nm, the presence of substrate elements such as Fe, Ni and W is understandable. If the thickness of the tribofilm on the wear scar is small, the substrate material composition (Ni, W and Fe) should be higher or increase with the etching time (depth). Through this hypothesis, it was found that the materials in the wear scars generated in the mineral oil were extremely thin compared to the materials in the wear scars generated in the FF oil. Based on the sputtering depths in the figure, it was concluded that the NiW coating tested in the FF oil had the maximum thickness of additive derived material in its wear scar.

The EDS mapping of the NiW wear scar formed in the FF oil after 432 m sliding distance was also analyzed. A high-resolution SEM image indicated that the material in the wear scar consists of “pad-like” structures. Moreover, these “pad-like” structures were found to mostly consist of a combination of calcium, and oxygen. Smaller amounts of zinc and sulphur agglomerates were also observed, but the presence of phosphorus could not be confirmed through EDS.

The EDS mapping of the uncoated sample tested in the FF oil showed that the structure of the additive derived material differs from the one observed in EDS mapping of the NiW wear scar. The material was found to have a large amount of oxygen, and the presence of calcium, carbon and phosphorus was also confirmed.

### Discussion:

Although no articles have been previously published on the tribological performance of NiW coatings in lubricated conditions, some previously published articles have focused on understanding the generation of additive-derived tribofilms on Ni-P and AISI 52100 surfaces. Periera et al. studied the formation of tribofilms on AISI 52100 steel tested in two lubricants, a FF oil and a ZDDP added mineral oil. They reported that the friction and wear performance of the AISI 52100 in mineral oil with only ZDDP additives was observed to be better than the performance in the FF oil. Periera et al. also performed extensive XPS analysis on the wear scars and made several conclusions. First, they concluded that the detergent in the FF oil formed medium chain calcium phosphate in the tribofilm. Second, most of the Zn in the FF oil reacted to form ZnS (78%) and ZnP (22%). Third, thermodynamic assessments showed the spontaneous formation of calcium phosphates and ZnS. Finally, it was also shown that the ZDDP additive in FF oils did not act independently as an anti-wear agent. The additive initiated the tribofilm formation and then CaPO₄ and ZnS grows depending on the availability of cations. A second study was published where it was shown that the substrate changes the surface activity, tribofilm formation mechanism, and the wear performance. It was concluded that the performance of FF oil on Al—Si alloy was better than the mineral oil with just ZDDP. Also, the Zn in the tribofilm formed ZnS (˜85%) and ZnP or unreacted ZDDP (˜15%). The effect of substrate composition on tribofilm formation was also observed in a previous study. Vengudusamy et al. performed a detailed study of tribofilm generation on NiP. It was shown that tribofilms generated on NiP coatings in a FF oil formed “pad-like” structures similar to the ones observed in this study. These structures provided superior wear resistance compared to the uncoated steel surface. The thickness of the tribofilm was calculated to be about 130 nm and was composed of phosphate, sulphide and phosphide layers. It was also shown that the presence of higher concentrations of Zn and P can have a beneficial effect on wear performance, while the presence of only higher amounts of S based additives could have a detrimental effect on the wear performance of the coatings. Overall, these studies showed that the substrate and the type lubricant had significant effects on tribofilm formation and wear performance.

With the present invention, whereas tests performed in mineral oil had higher friction coefficients, and lower ball and disk wear, tests performed in the FF oil had lower friction coefficients, and lower ball and disk wear. It is believed that the observed differences in the friction and wear between the tests performed in the mineral and FF oils can be attributed to additive-derived tribofilms supplied by the FF oil.

In the mineral oil tests, the friction, ball, and disk wear all increased with increasing temperature. This behavior is consistent with a decrease in oil viscosity and an increase in asperity interaction. Due to the lower hardness and higher roughness of the NiW disks, higher wear was observed on the NiW coating tested in mineral oil. An increase in frequency instigated no change in friction but escalated ball and disk wear. The increase in wear with increasing frequency could be due an increasing displacement of oil in the contact resulting in more asperity interactions. The increase in distance (time) showed no change in friction however an increase in the ball and disk wear was observed. The increasing wear can be correlated with the continuous asperity interaction in mineral oil lubrication.

In the FF oil tests, the increase in temperature caused an increase in ball and disk wear for the 52100 pairing. The increase in frequency increased ball wear but had no effect on disk wear. Finally, for the 52100 pairing, the increase in distance (time) increased the ball wear and decreased the disk wear. This is atypical when the material from the ball transfers to the disk surface. As the ball and disk were the same material, the compositional experiments performed on the tribofilm could not discern the origin of the Fe in the tribofilm. However, higher amounts of Iron and Oxygen was observed through the XPS depth analysis (Error! Reference source not found.). The NiW/AISI 52100 pair tested in the FF oil experienced no wear with increases in temperature, frequency or distance. This observation is unusual and can be attributed to the formation of stable, additive-derived tribofilms on the NiW surface.

The a values shown in Table 3 were derived from least square fits to the plots of the slope of the wear (ball and disk) vs. dissipated energy. For wear tests performed in the boundary lubrication regime, α values can be divided into four wear regimes. α>1000 μm³/J can be considered to be a high wear regime, 100 μm³/J<α<1000 μm³/J as a moderate wear regime, 10 μm³/J<α<100 μm³/J as a low wear regime and finally, α<10 μm³/J as an ultra-low wear regime. Following this convention, only the wear of the NiW coated disks tested in mineral oil fell in the high wear regime. All other ball and disk a values were in either the low or ultra-low wear regimes. The negative a value of the uncoated 52100 disks tested in the FF oil signifies a decreasing wear volume. That is, more material is being deposited on the disk than removed by wear. The deposited material is likely transferred from the ball to the disk. The presence of oxide (possibly iron oxide) found by EDS and XPS on the 52100 disk tested in the FF oil provides evidence for material transfer from the ball to the disk in form of debris. The a value for the NiW coated disks tested in the FF oil was zero as no measurable wear was observed.

The high wear on the NiW coated and uncoated samples tested in mineral oil was correlated with a thinner separation between the contacts thereby causing an increased asperity interaction between the two metal surfaces. The asperity contacts could result in antagonistic wear of the softer counterpart (e.g., the NiW coating). Since no additives were in the mineral oil, no tribofilms were found on the surfaces. Moreover, the higher roughness of the NiW coating could have resulted in higher wear of the coating. The mineral oil used in this study was an API Group II base oil and the amount of Sulphur content was assumed to have been <0.03%. Therefore, the tribochemical interactions to form any tribofilms between the Sulphur in the mineral oil and the samples is considered to be negligible. To conclude, the wear that occurred in the mineral oil tests was assumed to be predominantly mechanical in nature (abrasive wear).

SEM images of the wear tracks, XPS depth analysis compositions, and EDS scans of the wear tracks were considered. Whereas the SEM images confirmed that the wear tracks of the samples tested in mineral oil exhibit signs of mechanical wear, the samples tested in FF oil had a tribochemical wear contribution due to the additives in the FF oil. Interestingly, the difference in the formation of the tribofilms on the NiW coated and the 52100 samples tested in the FF oil was also evident. SEM images showed that the NiW coated sample tested in the FF oil had “pad-like” structures comprising the additive-generated tribofilm, and the uncoated sample had a dense tribofilm but also with abrasive marks.

From the XPS analysis, it was found that the wear scars of the 52100 tested in the mineral and FF oils exhibited high amounts of carbon and oxygen. However, even though the carbon concentration decreased with increasing depth, the oxygen concentration was found to be consistent indicating presence of oxidation products. The presence of oxygen could be due to the grinding process oxidizing the surface and/or possible material transfer of iron oxide from the ball to the disk. The XPS and EDS scans of the samples tested in the FF oil showed the presence of calcium, carbon, oxygen, zinc, and sulphur. From the EDS maps, the formation of ZnS in the tribofilm formed on the NiW during the FF oil test was confirmed. It is possible that the Ni and W wear debris (oxides and metal ions) could have participated in forming a harder tribofilm on the NiW surface. Previously, studies have shown the presence of a small amount of Fe in the tribofilms. Similarly, the formation of WS₂ nanoparticles on steel surfaces have been observed when oils containing S-based EP additives were tested. It was argued that the S from the additives reacts with W to form WS₂ nanoparticles. These thionization reactions are more favorable to occur between W and S than Fe and S. Additionally, the formation of layers composed of NiS and PO₄ has been observed in similar “pad-like” structure tribofilms.

### CONCLUSIONS

Tribological performance of NiW coatings and uncoated 52100 samples was studied under reciprocating sliding contact in mineral oil and a fully-formulated oil. Temperature (40, 80 and 120 C), frequency (20, 40 and 60 Hz) and distance (144 m, 288 m and 432 m) were varied to observe the change in friction and ball and disk wear. It was found that,

The friction coefficient of the NiW coated sample tested in the FF oil was lowest while varying temperature, frequency and distance, whereas the friction coefficient of the NiW coated sample tested in the mineral oil was highest while varying temperature, frequency and distance.

The highest ball and the disk wear was observed in the NiW/52100 pairing tested in mineral oil.

No measurable wear was observed on the NiW coated sample tested with the FF oil (up to 432 m or 180 min).

SEM analysis of the wear scars showed distinct “pad-like” structures on the surface of NiW coating after testing in the FF oil.

XPS depth analysis showed that the tribofilm generated on the NiW coating during the testing in the FF oil was thicker than in the other tests. Wear scars generated in the mineral oil tests mainly contained C and O, while wear scars generated in the FF oils mainly consisted of C, O, S, Ca, Zn and P.

High iron oxide concentrations were observed through XPS on the surfaces of the 52100 disks that were tested in both the FF and mineral oils.

EDS mapping showed that tribofilms generated on the 52100 disks tested in the FF oil exhibited primarily C and O, while the tribofilm on the NiW tested in the FF oil contained ZnS, C, Ca and O.

What is claimed is:

1. A lubricated system comprising:
at least one metal component in motion and lubricated by a lubricant including organic oil additives, wherein the at least one metal component is coated with a catalytic material.

2. The lubricated system of claim 1, wherein the presence of the catalytic metal improves the tribological performance of the system as compared to an identical system without the catalytic metal coated on the at least one metal component.

3. The lubricated system of claim 1, wherein the at least one metal component is selected from the group consisting of automotive drivetrain systems including engines, transmissions, axle centers, wheel ends, power transmission devices in construction, mining, agricultrue, and aerospace applications, shafts, bearings, bushings, gears, rollers, rolling bearings, plain bearings, gears, pistons, piston rings, tappets, and seals and wherein the at least one metal component is made of metals or metal alloys selected from steel, aluminum, magnesium alloy, titanium alloy, and metal matrix composites.

4. The lubricated system of claim 3, wherein the at least one metal component is made of AISI 52100 steel.

5. The lubricated system of claim 1, wherein the lubricant is selected from the group consisting of petroleum-based oils, semi-synthetic oils, synthetic oils, greases with mineral or synthetic oil, di-ester oils, and silicone oils; wherein the organic oil additives are selected from the group consisting of extreme pressure additives, anti-wear additives, friction modifiers, detergents and combinations thereof; and wherein the catalytic material is selected from the group consisting of catalytic metals and catalytic metal alloys.

6. The lubricated system of claim 5, wherein the catalytic metals are selected from the group consisting of nickel, palladium, platinum, copper, silver, and gold.

7. The lubricated system of claim 5, wherein the catalytic metal alloys include catalytic metals and a secondary alloying elements; wherein the catalytic metals of the catalytic metal alloys are selected from the group consisting of nickel, palladium, platinum, copper, silver, and gold; and wherein the secondary alloying elements of the catalytic metal alloys are selected from the group consisting of tungsten, phosphorous, vanadium, molybdenum, iron, and copper.

8. The lubricated system of claim 7, wherein the catalytic metal alloy is selected from the group consisting of NiW, NiP, NiCu, PdCo, MoCu, and NiV.

9. The lubricated system of claim 1, wherein the catalytic material is coated on the at least one metal component by an electrochemical deposition technique, wherein the electrochemical deposition technique is selected from the group consisting of direct current electrochemical deposition, pulsed current electrochemical deposition, and pulse reverse current (PRC) electrochemical deposition.

10. The lubricated system of claim 9, wherein the catalytic material is coated on the at least one metal component in layers using pulse reverse current (PRC) electrochemical deposition, and wherein the number of layers coated is between about 5 and about 200.

11. The lubricated system of claim 10, wherein the thickness of the layers is between about 1 micron to about 50 microns.

12. The lubricated system of claim 1, wherein the coated catalytic material has a hardness of from 7 GPa or more to 11.5 GPa or less.

13. A method for improving the tribological performance of a metal component in motion in a lubricated system including a lubricant with organic oil additives, the method comprising the steps of: depositing a catalytic material on the metal component.

14. The method of claim 13, wherein the catalytic material is deposited on the metal component utilizing pulsed reverse current electrochemical deposition.

15. The method of claim 14, wherein during the process of the pulsed reverse current electrochemical deposition, an electrolyte solution is used, the metal component acts as a cathode, and the catalytic material acts as an anode.

16. The method of claim 14, wherein during the process of the pulsed reverse current electrochemical deposition, the metal component acts as a cathode, the catalytic material is made available in an electrolyte solution, and materials selected from the group consisting of platinum, graphite, stainless steel, or combinations thereof. act as an anode.

17. The method of claim 13, wherein the process of the pulsed reverse current electrochemical deposition utilizes a waveform with cathodic and anodic currents.

18. The method of claim 17, wherein the cathodic current has a current density of from 5 mA/cm² or more to 80 mA/cm² or less and the anodic current has a current density of from 0 mA/cm² or more to 50 mA/cm² or less.

19. The method of claim 18, wherein the cathodic current has a pulse time of from 2 ms or more to 1000 ms or less and the anodic current has a pulse time of from 1 ms or more to 800 ms or less.

20. The method of claim 13, wherein the deposited catalytic materials have a hardness of from 7 GPa or more to 11.5 GPa or less.
